(19) United States
(12) Patent Application Publication
(10) Pub. No.: US 2002/0080938 A1
(43) Pub. Date: Jun. 27, 2002

(54) Method and apparatus for generating dynamic graphical representations and real-time notification of the status of a remotely monitored system

(76) Inventors: Wade H. Alexander III, Yardley, PA (US); John D. Dickinson JR., Pottstown, PA (US)

Correspondence Address: STUART H. NISSIM, WOODBRIDGE & ASSOCIATES, P.O. BOX 592, PRINCETON, NJ, 08542, US

(21) Appl. No.: 09/861,816

(22) Filed: May 21, 2001

Related U.S. Application Data
(60) Provisional application No. 60/205,686, filed on May 19, 2000.

(51) Int. Cl. H04M 11/00

(52) U.S. Cl. 379/106.01

(57) ABSTRACT

A plurality of self-contained remote environmental data-monitor-control units communicate with a central collection point, including transmitting and receiving data, control signals, program parameters and alert signals. The central collection point includes a web page interface allowing end users to view real-time, current status as well as trended data in textual or graphical form. The central collection point processes and forwards alert signals received from a remote environmental data-monitor-control unit or a third-party monitoring system to an alert notification system which can accept alert signals via email, page, and direct point-to-point communication, processes the alert signal to verify validity and eliminate redundant signals, and notifies one or more pre-selected recipients of the condition which caused the alert via confirmable, person-to-person notification.

This application claims priority from U.S. Provisional Application No. 60/205,696, filed May 19, 2000, the entire disclosure of which is hereby incorporated by reference.

### BACKGROUND OF THE INVENTION

1. Field of the Invention

This invention relates generally to monitoring devices. In particular, the invention encompasses a method and system for monitoring the status of one or more systems at one or more sites and collecting and processing the status data, in real-time, at a remote centralized location. A person-to-person notification can be initiated from the remote centralized location upon the occurrence of certain conditions of a monitored system. Communication between the monitored system and the central collection location may be via a suitable wireless communication medium, a wired connection, or any industry standard protocol for communication.

The system also provides for a remote user to be able to: control the monitored system, program monitoring and control parameters at the monitored system, to view real-time or trended archived status data, and to receive person-to-person notification of the status of the monitored system.

2. Description of the Prior Art

Sensors which transmit analog signals, generally in the form of a variable voltage or current, to a controller or receiver are known. Sensors having digital outputs are also known. Examples of typical sensors include devices which measure: room temperature, fluid temperature, gas temperature, steam temperature, fluid level, gas level, contaminant level, radiation level, levels of specific gases, such as carbon monoxide, levels of specific chemicals, such as cyanide, CFCs, solvents, gasoline additives, petroleum products, in addition to gas pressure, steam pressure, fluid pressure, speed, degree of rotation, speed of rotation, and Global Positioning System location, among others. Any sensor capable of analog or digital output is suitable for use in the present invention. Sensors, such as these, operate by collecting information from the environment in which they exist and by converting the received signals to an electrical signal capable of being interpreted by a device such as a Programmable Logic Controller (“PLC”), which can traditionally take the form of an Application Specific Integral Circuit (ASIC) or other suitable microprocessor-based device.

A PLC is a device normally consisting of one or more circuit boards with components and connections used to convert the electrical data gathered by sensors into useable data for other controllers, computer programs, and for storage, for example. Data gathering through a PLC allows for control of real world devices, for example, motors and switches, through additional circuitry and related devices mounted on a circuit board. Digital sensors can work with analog PLCs, and vice versa, using, as known to those skilled in the art, digital analog conversion (DAC) chips which are generally included on integrated circuits. Additionally, chips that include built-in logic are also included. The logic can then determine if a particular condition exists and/or if there is a need to activate at a given output.

A PLC or receiver incorporated into a monitoring system collects electronic data from various sensors at voltages or currents acceptable by the PLC in real time. Typically, input voltages vary from 0-10 v, while input currents can range from 4-20 mA, for example. The PLC also controls the transfer of data from the sensors to a collection or storage means, such as a memory device which logs data indicative of the sensed condition. The PLC typically is configured to communicate with the sensors and the collection means.

It is desirable and an object of the present invention to provide a device and system for providing real-time monitoring applications which are ill-suited for conventional PLC monitoring systems. Examples of such applications include, but are not limited to: trending of real-time and archived data, two-way communication allowing remote programming and control, self-contained monitoring units which can be deployed in remote and dangerous locations, and confirmed person-to-person notification of critical status conditions.

### SUMMARY OF THE INVENTION

A method and system for remotely monitoring at least one condition at a given location is comprised of at least one monitoring device at the given location which can generate data indicative of the monitored condition and transmit the data to a remote centralized data collection device. The data is transmitted by first wrapping the data in a given protocol which can be transmitted over the means selected for transmission, such as the internet.

Upon receipt of the wrapped data, the centralized collection device unwraps the data, determines the nature and source of the data, and stores the data for later retrieval. The centralized collection device generates a modified data string which includes identification of the sending monitoring device, such as owner, name and location, by retrieving stored data for the identified condition. If the centralized collection device determines that an end user needs to be informed of the condition data, using preprogrammed parameters, the centralized collection device sends the data to a notification system which generates a list of recipients, depending upon the nature and source of the condition, as well as other possible parameters, and initiates a telephone call to one or more of the designated recipients, and confirms successful notification of the condition. In addition, the monitoring device can be remotely and at least partially controlled and reprogramming by, in part, reversing the condition transmission process. The command or programming instructions are wrapped in a transmission protocol, sent to the monitoring device where it is unwrapped. The monitoring device evaluates the type of information sent and either executes the command, such as changing the position of a switch or requesting the current status of a condition, or by incorporating the new program code into the program currently residing on the monitoring device.

### BRIEF DESCRIPTION OF THE DRAWINGS

The advantages and features of the present invention will be understood by reference to the following specification in conjunction with the annexed drawings, wherein like elements have been given like numbers.

An illustration of the various processes involved with the device and method of the system can be seen by referring to the following Figures, of which:

FIG. 1 is an illustration of the overall process according to the invention.

FIG. 1a is an illustration of a single EDMC unit of FIG. 1.

FIG. 1b is an illustration of the selective placement of the sensors which are coupled to the terminal strip of the PLC of FIG. 1.

FIG. 2 is a schematic illustration of the various sensors of the assembly according to the invention.

FIG. 2a is a schematic illustration continuing from FIG. 2 of the logic which determines whether values are transmitted according to the invention.

FIG. 3 is a schematic illustration of an output and associated feedback of the controller according to the invention.

FIG. 4 is a schematic illustration of a communication process continuing along line B-B of FIG. 3 according to the invention.

FIG. 5 is a schematic illustration of a power supply according to the invention.

FIGS. 6 and 6a is a schematic illustration of the logic process at the central collection point.

FIG. 6a is a continuation of FIG. 6.

FIG. 7 is a schematic illustration of an alert notification system according to the invention.

### DETAILED DESCRIPTION OF THE INVENTION

During the course of this description, like numbers depict like elements throughout.

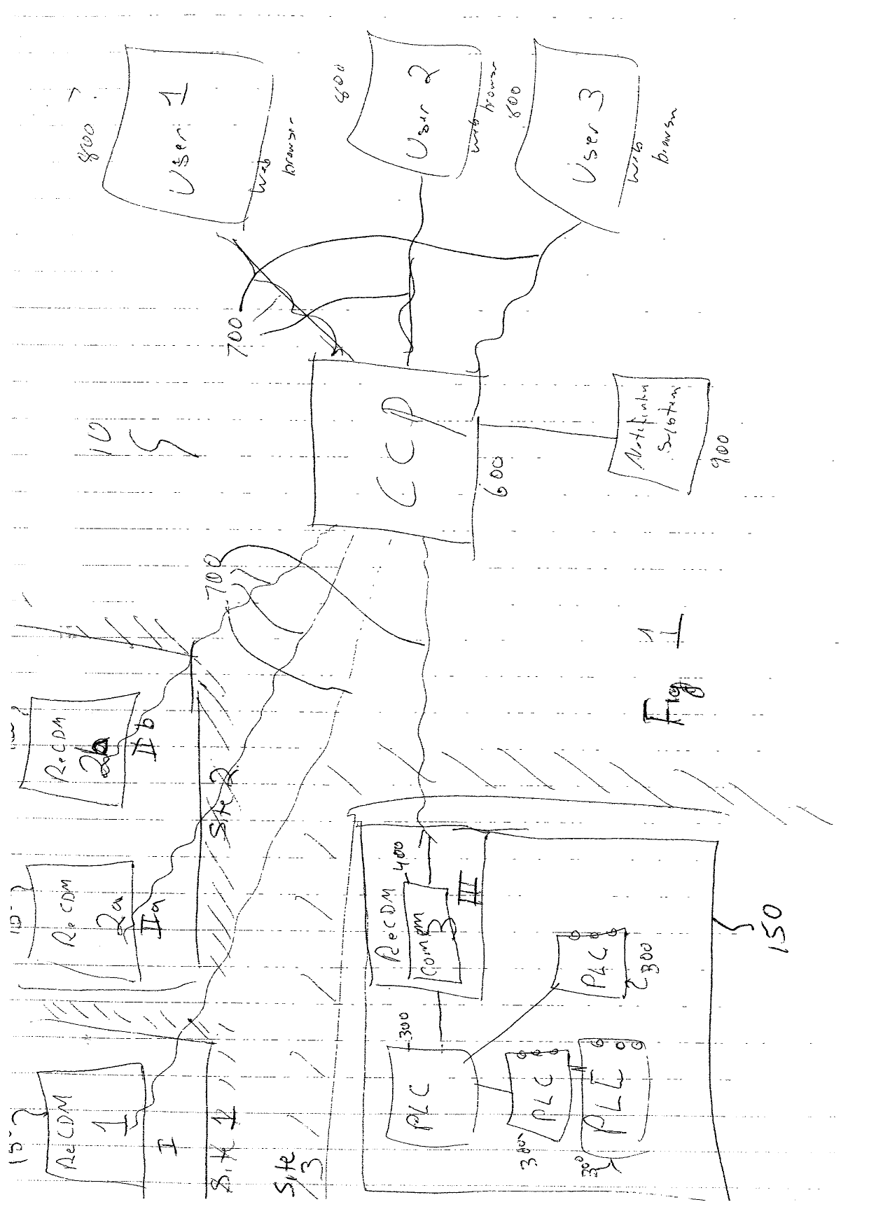

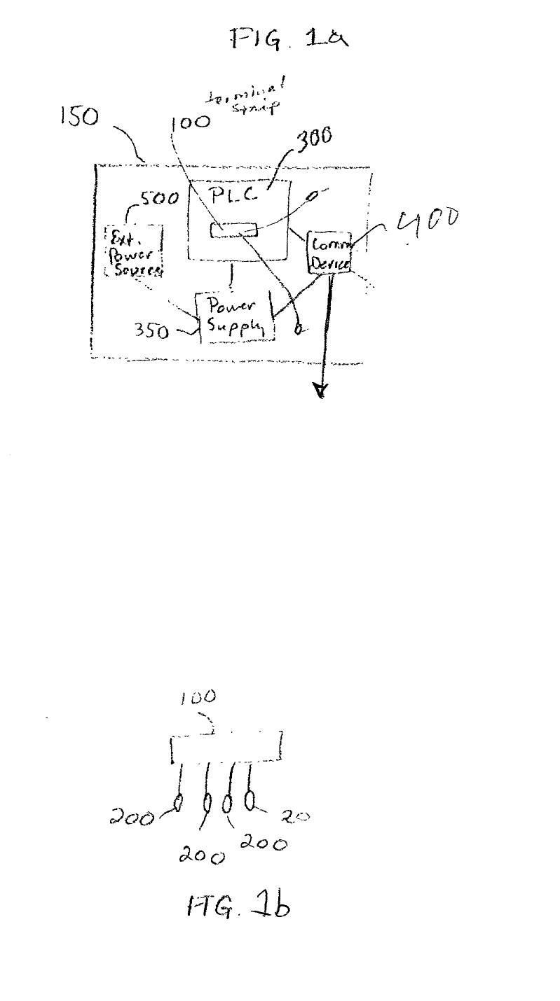

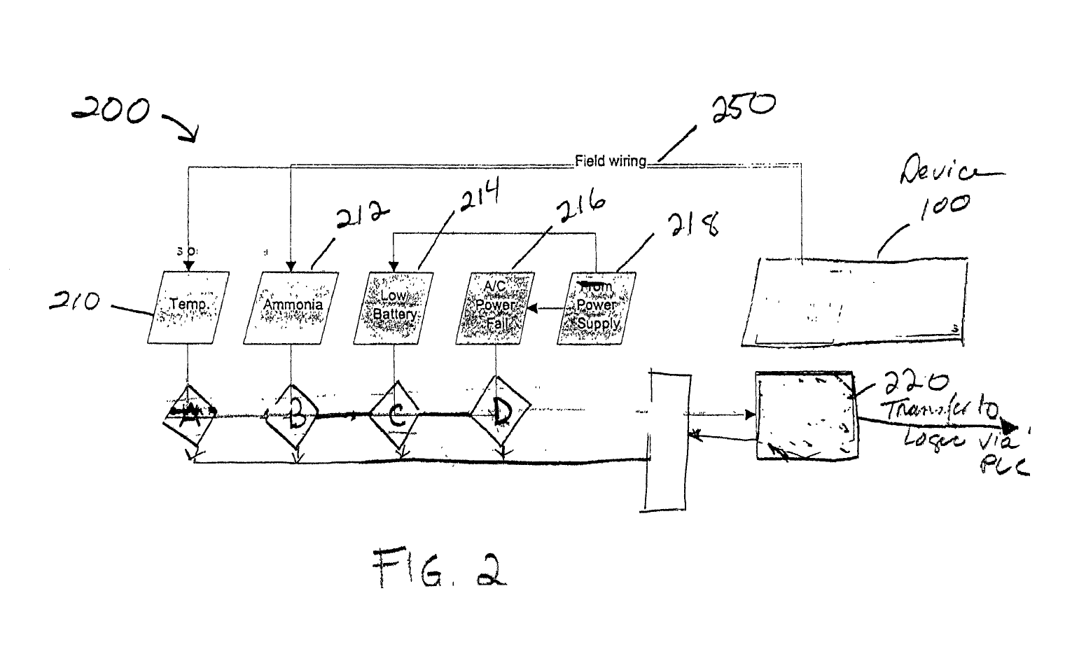

Referring to FIG. 1, an overall process 10 according to one aspect of the invention is illustrated therein. A plurality of remote Environmental Data-Monitoring-Control units (EDMC) 150 are located at one or more users' sites. An EDMC is generally comprised of:

a) one or more sensors 200 attached to a PLC 300. Individual sensors can monitor different conditions of the same monitored device/system or the same condition for different monitored devices/systems;

b) at least one PLC for receiving data from the sensors, applying logic 220 to received data and commands, controlling output relays and voltages, generating alerts, and interfacing with a communications device 400;

c) a communications device for sending sensor data, alerts, and confirmation signals to a central collection point 600 and for receiving requests for data, control signals, programming data and supervisory signals; and,

d) a power supply with appropriate power for any sensors, PLCs and the communication device.

A user's site may have one or more EDMCs depending upon configuration, requirements and limitations of equipment. For example, distance or location of monitored systems may hinder the use of a single EDMC; to restrict user access to particular EDMCs either physically or through the web 800; or an individual EDMC may be limited to the number of sensors or controls it can access.

All of the deployed EDMCs at all users' sites communicate with a single centralized collection point 600. The CCP 600 may be comprised of a single unit or multiple units which can be separate or co-located and share/distribute the duties and load of the CCP 600. Some of the advantages of this many-to-one architecture of the system include the ability to interface with existing historical systems and proprietary collection, monitoring and control systems and sensors which can ultimately communicate with the CCP 600, as well as, the ability to deploy totally self-contained EDMC units in remote or dangerous, hazardous locations, including the ability to deploy by extreme means such as parachute drop, remote-controlled robot, or as a payload in a rocket, mortar, shell, or missile.

The CCP 600 also acts as a centralized storage facility for data collected from users' sites. All data received by the CCP 600 is stored in one or more files on one or more storage devices. The files could be an “SQL’ compliant database, a relational database, a flat file database, a text file, or the like. The storage device could include a hard drive, CD-ROM, CDR-ROM, CDRW-ROM, DVD, DVD-RAM, magnetic tape, or the like. This allows for future retrieval of single or multiple records for review by the user or for system maintenance and security.

The CCP 600 acts as a single, centralized access point for users to review the status of, reprogram parameters and control the monitored devices/systems. The CCP 600 provides user interactivity via a web site which can be static, dynamically generated or a combination of both. User interactivity through the web page can be implemented through html, xml, java, cgi, perl, Cold Fusion®, Microsoft® asp, PHP, and the like. Each user could have access to, for example, a multitude of web pages, each showing different data, for different sites, different, EDMCs, or combinations thereof. Interactivity could include, for example, requesting and viewing the current, real-time status of one or more monitored sites or devices; requesting and viewing textual or graphical representation of trended data for particular sites, systems, sensors, or conditions for a given period of time stored on the CCP 600, for example the average daily temperature over the last two months. Also, the CCP 600 could restrict the ability and rights of certain users to view or control particular sites, EDMCs, sensors depending upon the users security level, etc.

Referring to FIG. 1a, an EDMC unit 150 according to one aspect of the invention is illustrated therein. Generally, an EDMC unit including a programmable logic controller (PLC) 300 having a terminal strip 100 coupled to sensors 200 on a user's site monitors real time conditions in the environment in which the sensors 200 are disposed, without the need for the user to be physically located at the site, through the global interconnection of computers and computer networks commonly referred to as the Internet 700. Sensors 200 monitor and provide signals indicative of at least one condition.

The PLC 300 is powered by power supply 350, which also includes external power sources 500 and internal battery backup power according to another aspect of the invention. External power sources 500 coupled to the power supply 350 include, for example, AC or DC sources, such as on site electrical supplies, batteries, solar, windmill, fuel cells, generators, or any other suitable external power source.

Upon receiving the signal output from sensors 200, the PLC 300 transmits the data to a preferably wireless communication device 400, such as a modem and RF transmitter, which in turn communicates with a centralized collection point (CCP) 600. At CCP 600, in this example a server or other computing device remotely located from the user's site, the data indicative of the monitored condition is processed and stored and an alert notification is transmitted from an alert notification system 900 if selected parameters are met by the processed data. The transmission of an alert is optional.

The alert notification system 900 provides person to person notification of problems, failures, critical conditions, and restoration of monitored environments, systems, circuits, computers, equipment, etc. According to one aspect of the invention, the alert notification system 900 accepts an e-mail, page, or proprietary signal, processes the e-mail, page, or proprietary signal, and thereby generates one or more alert notifications. The alert sent is determined by preset parameters for alerts from a particular location monitored by a sensor. For example, a live human operator is notified of an alert condition, who follows a selected script of action to take, primarily this may include calling a list of personnel supplied by the user, and proceeding down the list until a live person-to-person notification of the alert condition is made. Alert parameters can be modified, activated or deactivated according to another aspect of the present invention.

As known to those skilled in the art, monitoring services for monitored systems are available, and traditionally may include page alert or e-mail capabilities. These systems, however, do not confirm that the alert/restore notification was received. The present system ensures that the alert reaches the selected recipient by confirming receipt through direct person-to-person communications. A contacted user can determine, upon receipt of the notification, whether the condition that generated the alert warrants some additional action such as, that a technician be sent, and the type of technician to send to the site, if necessary. The present system also provides multiple levels of signal authentication to prevent “hacked” alerts. According to another aspect of the invention, redundant pathways to the alert notification system 900 are employed to ensure alert notification regardless of whether one of the notification pathways, for example the user's email server, is offline, which may occur at a critical time.

Alerts may take the form of an email, alpha page, numeric page, live person notification, and combinations thereof. Although a server is exemplified, a suitable CCP 600 for use with the present invention includes any suitable microprocessor-based device utilizing a suitable operating system, and other industry recognized devices capable of processing data and transmitting alerts known to those skilled in the art. CCP 600 is coupled to a display 800 upon which the current status of the data, in this example a web page, is displayed and accessible by the Internet 700.

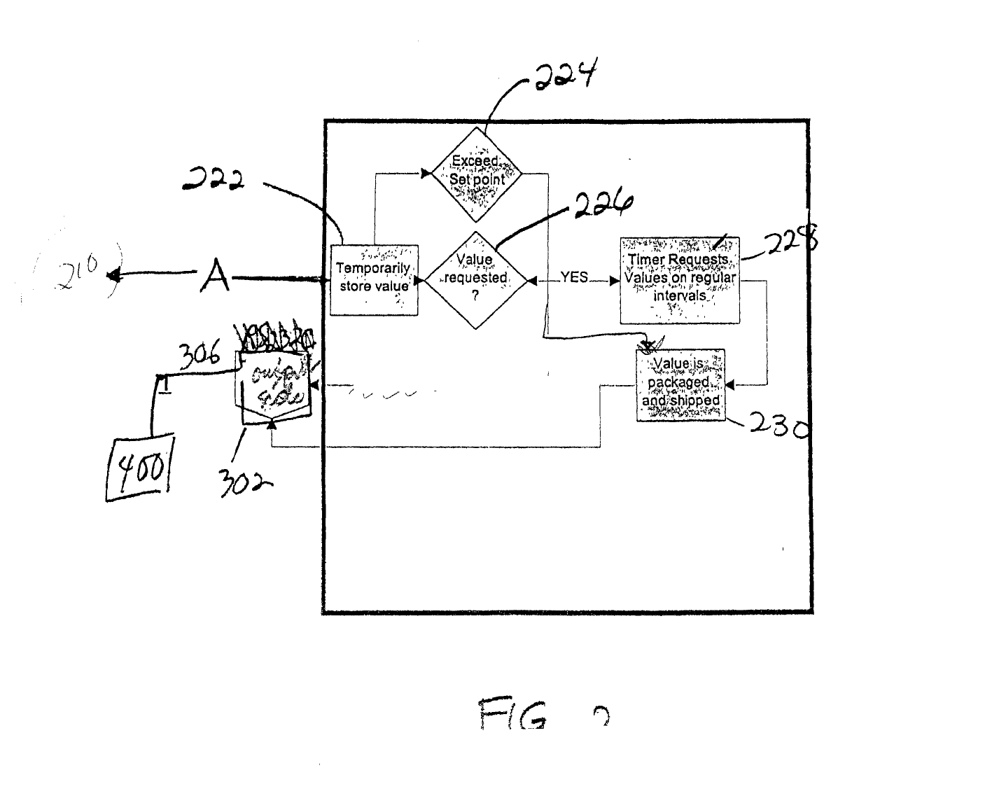

Referring to FIG. 2, an example of how the sensors 200 of the process 10 may be used. A plurality of sensors 210, 212, 214, and 216 are shown to exemplify the various types of input data that is monitored and relayed using the present process. Many different combinations of sensors may be selected. For example, sensor 210 may be selected and operates to measure temperature, sensor 212 operates to measure ammonia levels, sensor 214 operates to measure the internal backup power supply (not shown), and sensor 216 operates to measure primary power supply failure. It is to be understood that sensors 214 and 216 operate concurrently with separate power supply 218. Sensors 210-216 are connected via field wiring 150 to a terminal strip 100.

Each sensor 210, 212, 214, and 216 measures a value such as temperature concurrently and preferably independently of each other sensor. As set forth above, sensors convert analog signals to a readable electrical signals or pulses that are transmitted to the PLC 300. The signal is typically a voltage in the range of 0 to 10 volts or 4 to 20 milliamperes. The PLC 300 interprets and converts the pulses to a digital form of data by hardware on the PLC 300.

It is to be understood that sensors typically have limits in range of capability. For example, a value, such as a high limit and a low limit, is selected by the user such that when either of the limits, or set points, are reached it causes the sensor to cease changing its transmitted value. This causes a condition of non-operation but does not constitute sensor failure. The sensor will again begin transmitting changes of value once the physical condition returns to a status within the minimum and maximum range of the specific sensor. A notification process may be initiated or an alternative automated action process may also occur which is determined by the logic 220.

Data received by the PLC 300 is evaluated by the hardware and compared to a conversion table stored on the PLC 300 for the particular type of sensor. An identifier is assigned to the signal, and the data is then fed into a small on board program that does not come from the PLC manufacturer but rather is compiled by the user. The language of this program is determined by the PLC manufacturer and is normally proprietary.

In the present invention, the program is used for collecting data at regular intervals for trending, and for constantly monitoring the reading of the sensor to ensure it has not exceeded one or more programmed set points. The PLC 300 passes values it receives to the logic 220, if any, and then the logic 220 processes the values accordingly. A set point is a value selected by a user that represents an undesirable condition for which the end user desires a record, a notification, or both. A record is stated in other terms as a trend or a continuous record of events or values such as room temperature.

The input is identified, such as A, for example, and the value and input ID is then transferred to the logic 220 of the PLC 300. The PLC 300 is configured to recognize the input ID and process the signal, if at all, depending upon the value and source (i.e., input ID). For example, the minimum set point temperature for a sensor/input may be 25° C. and the maximum set point temperature may be 35° C. The environment's temperature is continuously monitored by the sensor 210 which provides an electrical signal to the PLC 300 via field wiring 150. The PLC 300, using suitable programming, determines whether the measured temperature at the site is between the minimum and maximum selected values. When the sensor transmits a value outside of the range of the selected values, the PLC 300 generates an alert. Thus, upon the sensor transmitting a signal corresponding to a temperature of 40° C., for example, an alert is generated by the PLC 300.

In response to an alert, an output on the PLC 300 can be activated. In the present example, an exhaust fan may be selectively activated to reduce the temperature at the locus of the sensors, for example. This could be achieved either through the logic 200 on the PLC 300, via a program on the CCP 600, or by end user input via the web page 800. It is to be understood that a deadband of, for example 5° C. can be programmed into the logic to prevent the fan from repeatedly turning on and off if the temperature oscillates between 39.9° C. and 40° C. as is well understood. If no change in value is detected, no action on the output is taken by the PLC 300.

As set forth above, suitable logic 220 is programmed into the PLC 300, in this example, a set point value of 40° C. is programmed allowing for a difference or deadband of 5° C. as is conventionally understood, using the onboard chip set of the PLC 300. The PLC 300 employed in the present invention preferably operates with an RS232C interface, a common standard device, but any suitable industry standard controller device capable of communicating may be used in the present invention.

Typically, the PLC 300 transmits data from the PLC board via a communications standard such as RS-485, RS-232, Ethernet, Backnet, or any other industry acceptable communication protocol to a secondary device, such as a computer or CPU based device. As known to those skilled in the art, a PLC generally goes back to any number of daisy chained proprietary devices or to a dedicated PC or via a local network that can interface to a computer operating with proprietary software.

In the present invention, the secondary device is not a computer or CPU based device but advantageously is a communication device 400 (such as a wireless CDPD modem, PPP Capable modem, Ethernet module or self contained network card or any other device which allows connection to the Internet) that receives the transmission of information in a checksummed format which is then placed into one or more packets of data compliant with industry specifications for transmission over the Internet 700. One preferred specification is commonly known as TCP/IP. Upon packaging the received string into TCP/IP format, the PLC 300 transmits it via the communication device 400, over the Internet 700, to the CCP 600.

At the CCP 600, the data is broken out of the packaging along with pertinent information regarding the source of the transmission from the Internet allowing for each individual packet to contain like information but being related to one of a multitude of user sites. Once the information is received at the CCP 600, a determination of why that data arrived takes place by simply comparing the value to known set point values. If nothing unusual is found in the value and it is time for a regular trend update then the information is simply logged to a storage device on the CCP 600 to database or a file in that user's directory, for example, for access via a web browser. All signals coming from a site's communications device 400 are tagged with unique identifiers at time of arrival to allow a single signal to be tracked all throughout the process of trending and reporting.

Advantageously, the user may access the parameter set points and modify them via web page 800 via the Internet 700. In a non-limiting example, a program on the CCP 600 connecting the user to a web page 800 capable of transmitting an appropriate signal to the PLC 300 allows a user to change the parameters or set points by reprogramming logic in the CCP 600 and/or the logic 220 in the PLC board 300. The program preferably has a remote user interface allowing another user to access the same program, provided the user has security rights.

More particularly, referring to FIG. 2a, the user may select numerous conditions to be monitored. Each signal transmitted by the sensor has an ID, such as A, B, C, or D, or other means of identification assigned thereto. Of course, more than four conditions may be monitored at any time, and the depiction of four temporary values is by example only. Any sensor that is capable of generating electronic data at input levels communicable to and acceptable by the PLC 300 is suitable for use according to another aspect of the present invention.

Referring to FIG. 2a, the data signal transmitted by the sensor 210, for example, A, is temporarily stored in the PLC 300 as a value 222. If the value 222 compared to a selected set point exceeds the selected set point 224, the value 222 is packaged (preferably with a checksum) and shipped 230 to the output side 302 of the PLC 300 by a program on the PLC 300, which is coupled to the communication device 400 via a wired connection 306. The wired connection 306 is a standard cable used in the industry to connect communication devices such as modems to computers. Preferably, a RS232C cable is used, as in the present example, but any suitable wired connection such as RS485 for example, may be used in the present invention.

In the present example, the temporarily stored value 222 may be requested 226 from timer requests 228 on regular intervals. The value 222 is packaged and shipped 230 to the output side 302 of the PLC 300 by a program on the PLC 300, which is coupled to the communication device 400 via a wired connection 306. It is to be understood that timer requests are software intervals. Intervals are elements of time elapsed between an action from the first collection of data to the following collection of data. A request may be made in a variety of ways. For example, the user may make a manual request via the web page 800 to update the data. Other examples of requests include time-based requests made by automation or programming or secondary requests made by other conditions initiating a need in the logic for current information.

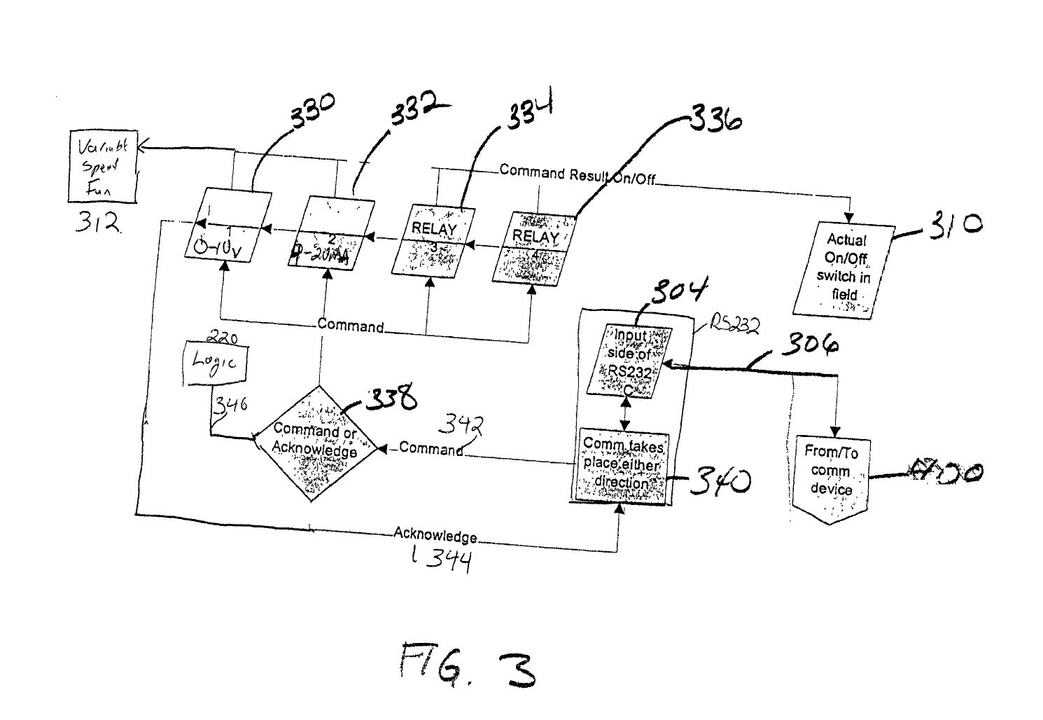

Referring to FIG. 3, the output and associated feedback of the PLC 300 is illustrated.

Through outputs at the terminal strip 100 the PLC 300 has the ability to control external devices through variable output voltages or currents 330, 332 and relay activation components (RAC) 334, 336, such as, for example, relays, or Silicon Controlled Rectifiers (SCR) (for DC control) and triacs (for AC control) Upon receipt, and processing, of an external command 344 from the CCP 600 or an internal command 346 from the PLC logic 220 the state of the targeted RAC is changed or a selected voltage or current is presented at the output points at the terminal strip 100. Internal commands can originate from logic 220 response to a condition on an input (sensor). External commands can be the result of a program which interprets user input from the web page 800 and sends the desired command to the EDMC 150.

In one embodiment the PLC 300 will generate and send a confirmation or status feedback signal 344 upon successful execution of a command. Examples of PLCs which send feedback signals include PLCs from ELK in Hildebran, N.C. and Parallax, Inc in Rocklin, Calif.

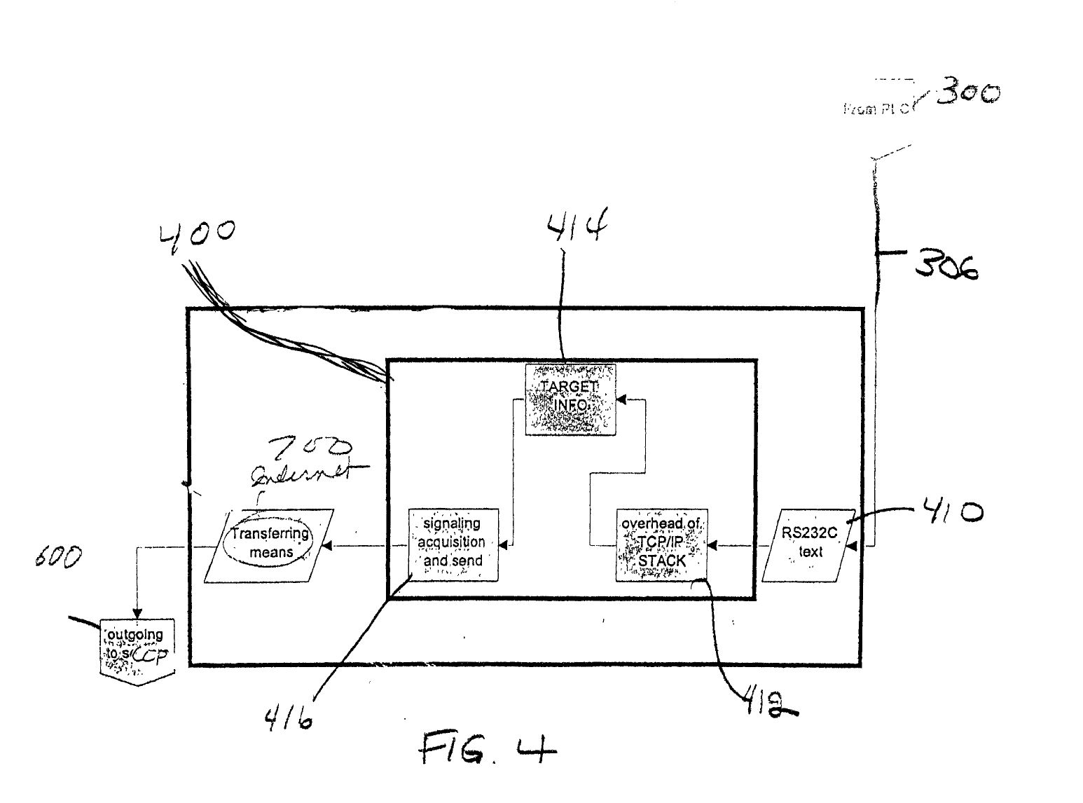

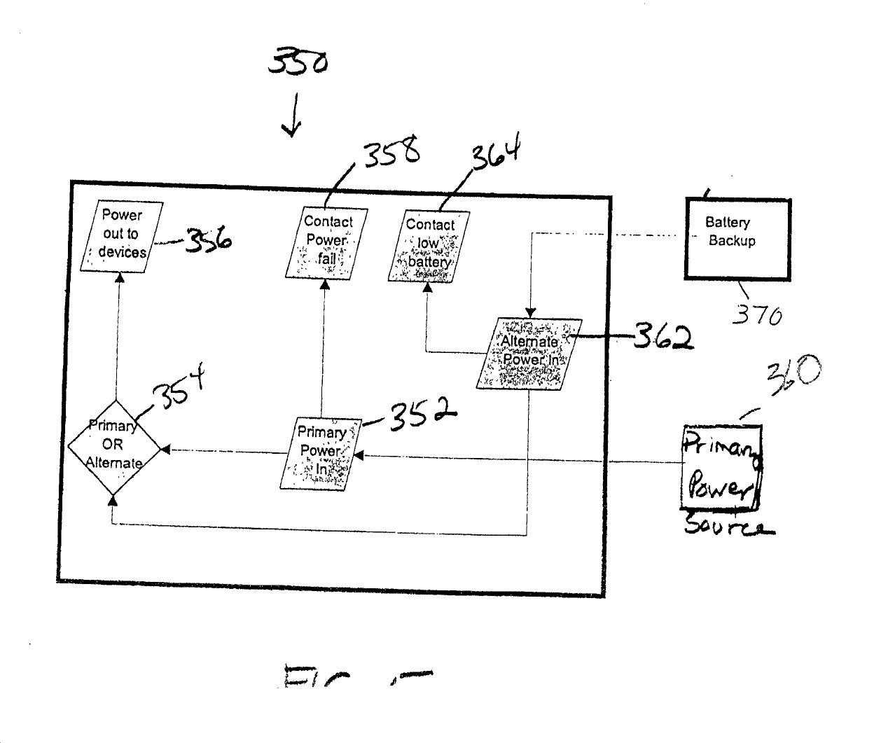

Referring to FIG. 4, an example of a communication device suitable for use in the present invention is illustrated. The communication device 400 shown is a typical wireless modem that receives, from the PLC 300 via wired connection 306, text in RS232C/RS485 format 410 or any other format acceptable to the PLC 300 used. The textual information 410 is packaged in a TCP/IP (Transmission control protocol/internet protocol) packet, also known as a data packet, and transmitted to the overhead of the packaging industry standard protocol for communication devices, in this example a TCP/IP STACK 412 which is transmitted to the target information 414, which in turn is transmitted to a signaling acquisition to establish communication and sent 416 over the internet 700 to the CCP 600. The packaging includes IPX/SPX, (interpacket exchange/service packet exchange) packets or any other industry standard protocol. In this illustration, a wireless modem is used, but any suitable communications medium standard in the industry may be used. Text info is packaged in a TCP/IP packet and transmitted via radio frequency (RF) to the global interconnection of computers and computer networks 700 specifically targeted, via IP address, for the CCP 600.

Likewise, a TCP/IP packet targeted for, and received by, the communication device is stripped of overhead and address information, and the remaining data/command signal is passed along to the PLC 300.

It is to be understood, that any communication device 400, wireless or not, may be used to establish Internet connectivity for the EDMC 150 as long as it provides a means for identifying the source/location of a signal, such as a public, static IP address, a MAC address, or an EIN number.

According to an aspect of the present invention, at least one PLC 300 receives status data from one or more sensors 200, and has a programmable microprocessor for processing the data received. As set forth, the PLC 300 may be selectively programmed to actively collect data from sensors coupled thereto at regularly scheduled intervals, or upon an external request, for example from the CCP 600, upon determining that input from a sensor meets certain parameters, or upon an alert from the PLC 300 when a set point is exceeded, for example. External signals, sent from the CCP 600, or from another PLC, may be sent to the PLC 300 for effecting the control of an external device connected to the PLC 300.

Sensors transmit data continuously or upon a change in physical conditions of the environment in which they are disposed, or at regular intervals. Upon receipt of a signal from a sensor, the PLC 300 can identify which sensor transmitted the data. The PLC 300 continuously receives and evaluates data signals transmitted from the sensors, but only processes and transmits data when requested or an alert condition exists. The PLC logic 220 proceeds to identify whether the signal was received due to an automated request, such as by a timer 228, or manual request, such as a specific request generated by program logic 220 due to a set point being exceeded. The data is then packaged by the PLC 300 and transmitted via a communication device 400, to the CCP 600.

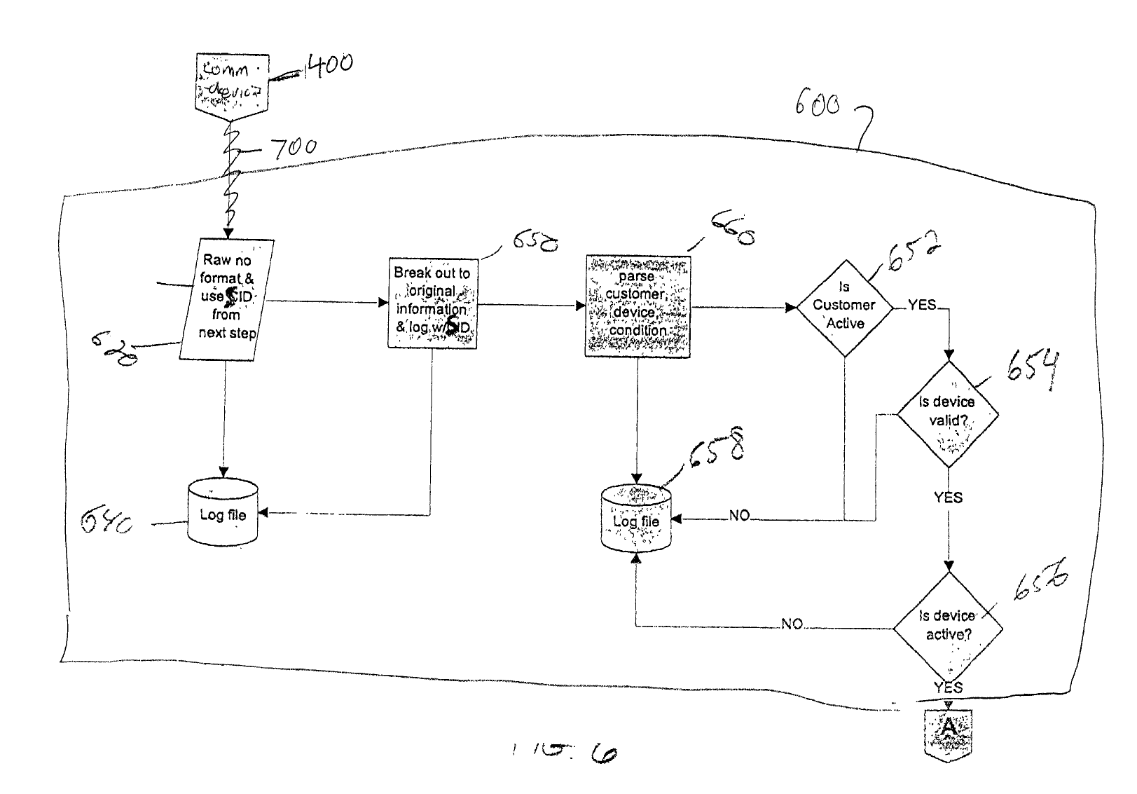

Referring to FIG. 5, a power supply 350 suitable for use in the present invention is illustrated. The power supply 350 includes an input 352 that accepts external power in a selected range. suitable primary power sources 360 include, solar, A/C, D/C, battery, fuel cell, wind, or generator, for example. The selected range may vary from one power supply device to another. In one embodiment the power supply 350 has the capability to automatically engage a battery backup 370, including supplying alternate power 362, notifying via dry contact closure of an A/C power failure 358, or low battery conditions 364, and powering out to devices 356, whether from a primary 352 or alternate 362 source.

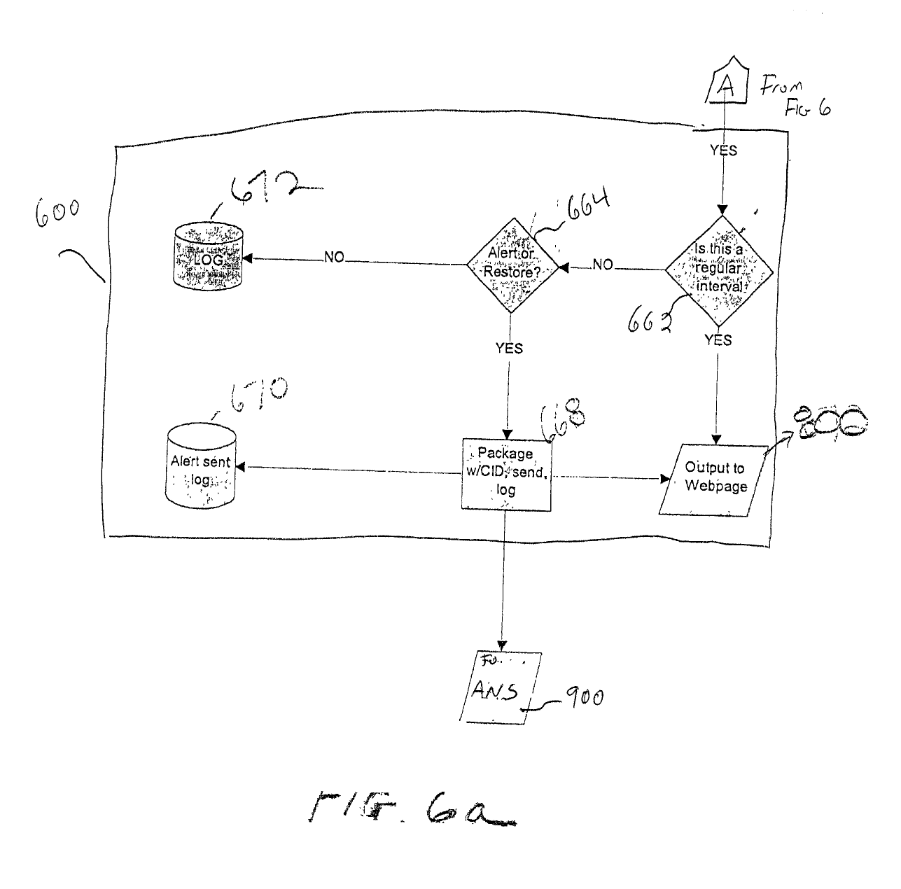

Referring to FIG. 6, the PLC 300 is programmed with an address identification (ID) to allow the CCP 600 to identify the particular PLC 300 which is the source of the signal. This PLC ID can be the simple numeric identifier, set with jumpers or DIP switches on the PLC (which is used to identify and distinguish PLCs that are interconnected on a PLC network or, the PLC ID can be an assigned “name” programmed into the firmware on the PLC as an alphanumeric string. This unique PLC ID is used in combination with the sensor (i.e., input) ID and one or more other source identifiers such as the IP address of the modem, router, firewall, or the like, which is used to connect to the internet; Caller-ID information for a modem using a phone line; the Media Access Code which is used to identify Ethernet NIC cards; the EIN of a modem, and the like. Thereby, for example, each signal generated by the PLC 300 and transmitted to the CCP 600, has a unique source ID which facilitates processing and displaying the location of the problem/status.

The CCP 600 generates a unique signal ID (SID) generated using some combination and form of time and date the signal was received, which is used to identify each individual signal received, for tracking, storage and later retrieval. Assigning a code, such as an SID allows all subsequent operations 650 to determine the appropriate action to take, based on the code.

Referring to FIGS. 6 and 6a, data signals are transmitted to the CCP 600, for example, via a wireless communications medium. The CCP 600 receives data from one or more EDMCs 150. The CCP 600 processes the signal data using the source identifiers to recognize the source and nature of the signal and stores it in a storage medium 640 designated for data from the particular source, such as an structured query language “SQL” enabled database, text file, or the like. If the CCP 600 identifies the signal as an alert signal 664, as a result of a signal sent outside of a regular interval 662, an appropriate alert is sent 670, the signal is packaged with the SID and logged 668. The output is transmitted to a web page 800, and output to the ANS as determined by preset parameters for alerts from that particular source. Alerts may take the form of an e-mail, alpha page, numeric page, live person notification, or combinations thereof. The PLC 300 may have a supervised power supply which, upon failure, generates signal data which the PLC 300 processes as an alert and sends the appropriate data and alert status to the CCP 600. If no alert or restore 664 is to be sent, the signal is logged in a log file 672.

The CCP 600 parses user information 660. If the user is active 652, such as maintaining a valid account, the process continues and it is further determined whether the monitored device 100 is valid 654 and active 656. If the device is active, 656, the process continues as exemplified in FIG. 6a and discussed above. When the user is inactive, or the device 100 is invalid or inactive, the data is transmitted to a log file 658, and the process is halted. A log file 658 is generic and may include one or more files. When halting the process, it may be necessary to simultaneously log the information to the web server 600.

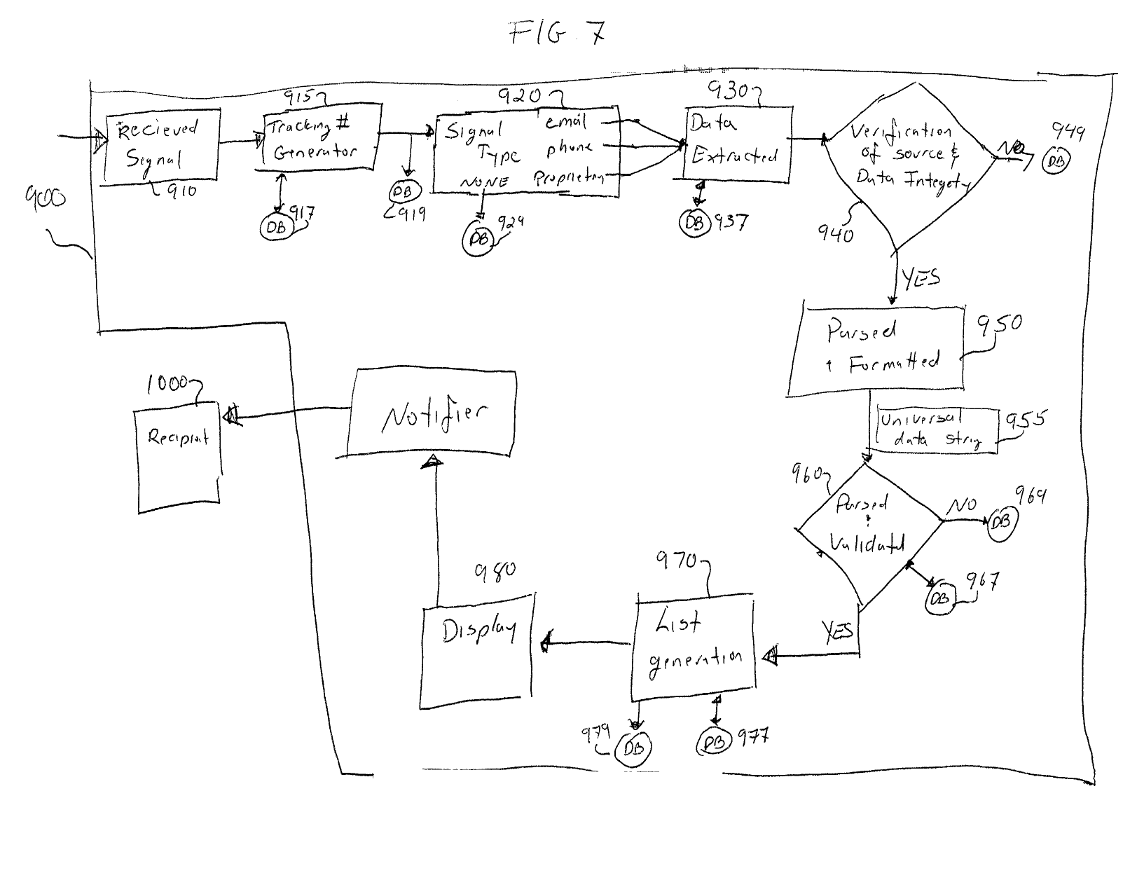

Referring to FIG. 7, an alert notification system (ANS) 900 suitable for use in the present invention is illustrated.

The ANS 900 is a system comprised of hardware and software capable of receiving the signal, processing the signal, and generating a notification when necessary. A text-based status signal 680 containing signal data is received 910 by the ANS. Upon receipt of a signal the ANS 900 first determines the type of signal sent 920. The type of signal received determines how the signal is further processed. The signal data contains information including, for example, time, date, sending source, identification information and other relevant status information. The ANS 900 then processes the status signal by extracting 930 the data necessary for further signal processing.

The signal data is then analyzed for verification 940 by analyzing one or more parameters included in the status signal to ensure the integrity of the data and to authenticate the source of the signal.

If a signal is verified it is then parsed and formatted 950 into a universal data format. The universal data string 955 includes a plurality of data fields, each separated by a field delimiter. Using a universal format allows for a multitude of different signal sources and formats to be subsequently processed in a common manner.

The universal data string 955 is parsed and validated 960 to check the validity of the string data. The validity is checked by comparing values of one or more of the universal data string data fields with acceptable values for the data fields. Acceptable values for universal data string data fields can be pre-programmed or stored in a data storage device 967, preferably in a text file or database. Typical data fields include, but are not limited to, time, date, signal source identification, monitored device identification, monitored device location and device status.

If a signal is validated a list generator 970 generates a list of recipients and their respective telephone numbers, and can also include additional information in the list, such as a particular message which is to be relayed to the recipient of the notification. The recipient list and any other data can be generated by retrieval from a database 977. The contents of the list is dependent upon the values of one or more validated data fields. A display 980 then displays, in a readable form, the list and any accompanying data. Typical display means include, a cathode ray tube, a printer, and an LCD display. More than one display means can be used to provide redundancy, confirmation and for archival purposes.

A notifier 990 then cycles through the list of recipients on the displayed list; calls each recipient on the list and notifies the recipient 1000 of the subject of the signal and any other message(s). Typically the notification means will stop cycling through the list and making calls after at least one of the recipients on the recipient list has been notified and receipt of the notification confirmed. Examples of notifiers 990 means include a live person using a telephone or an automated system including a phone dialer, a text to speech conversion and generation means and a notification receipt confirmation means.

Upon the occurrence of a condition, as delineated by a user, in a monitored device or system, a signal source, such as the CCP 600 for example, sends a status signal to the ANS 900 for processing and resulting live notification. The signal is preferably a text based signal. Acceptable text preferably consists of characters from the ASCII and Extended ASCII sets. Signals can be sent, for example, via email, alphabetic paging, numeric paging, remote serial data transfer, and direct connections such as serial, parallel and Ethernet, using appropriate protocols. Examples of other signal sources include, but are not limited to, a device or computer program which can generate an email message and can then send the email, preferably via protocols and routes known in the art. Examples of useful email protocols include, but are not limited to, POP3, SMTP, and MIME. Such emails are commonly sent to remote locations over a computer network which can be a local network, a wide area network, or the global interconnection of computers and computer networks, commonly referred to as the Internet. Another signal source includes any device capable of connecting to a telephone line, such as POTS or ISDN, and dialing one or more programmed numbers and pauses, which first dials a paging number and then “dials” the appropriate numbers, asterisk and pound symbols necessary to initiate a numeric page to be sent. An example of such a device is a telephony board simultaneously connected to a computer and a telephone line. Another signal source is a system capable of sending a page which contains both numeric, alphabetic, and other textual characters; such systems include e-mail based paging/messaging systems.

In a preferred embodiment, two signal sources are used in order to provide redundant, backup pathways to send a signal. For example a CCP 600 sends signals via email and via alphanumeric paging; both signals will contain analogous status and identification data, in the appropriate form for sending via the respective sending method. The different signal sources can be part of the CCP 600 or can be separate devices which communicate with the CCP 600 and generate and send signals.

The ANS 900, receives 910 the text-based status signal containing signal data. A single ANS 900 can receive signals from one or more separate signal sources. Examples of possible pathways used by the ANS 900 to receive a signal include, but are not limited to, a serial port, modem, e-mail client program, Winsock port, FTP connection, PPP connection, Telnet connection, or other public or proprietary protocol connection. Examples of preferred methods for receiving signals include, but are not limited to, a device or computer program which can receive and read an email message or a device, preferably in communication with a computer, which can receive and read pages.

A method of receiving email-type signals includes a computer program which can function as an e-mail client capable of receiving and reading email in POP3, MAPI, MIME, or other formats and a connection to a network over which the signal was sent.

Another method for receiving signals is a telecommunications device, such as a “Moon” board (commercially available and manufactured by Jackie Moon) or an EZ-4 board (commercially available and manufactured by Music Telecom) capable of receiving and reading numeric and/or alphanumeric pages.

Upon receipt 910 of a signal by the ANS 900 a unique tracking number is generated by a tracking number generator 915. A tracking number is specifically associated with the status signal being processed. The tracking number is added to the signal data to identify the signal throughout the remainder of the processing. The tracking number can be appended, inserted, or prefixed to the signal data. One form of a unique tracking number can be based, for example, upon a time stamp which can be generated by an internal or external clock (processor time, time of receipt, etc.) in combination with a unique signal identifier which is preferably a number generated in a progressive, serial manner so that no two signals will have an identical signal tracking number. The value of the signal identifier number is associated with and maintained by each ANS 900 independently of other ANS 900. The signal identifier number can be temporarily or permanently stored in memory, such as RAM, or a data storage device 917, preferably in a text file or database.

As used throughout this application, the term data storage device refers to any device or method for the temporary or permanent storage of information. A data storage device can have read-only, write-only, or read/write capabilities. Such capabilities shall be determined by process requirements, such as the function of the data to be stored and/or accessed. A data storage device may store such data in any form including analog and digital. Examples of typical data storage devices include, but are not limited to: paper tape; paper cards; magnetic media such as ROM, RAM, floppy drives, hard drives; optical storage such as CD-ROM, DVD, and holographic storage; molecular-based storage, chemical based storage, and any other means which will provide the required access to the stored data. The data can be stored in any acceptable and useable format, including, binary files, text files, or database files.

The signal identifier number can start at any value but preferably starts at zero or one. The signal identifier number can be periodically recycled so that the generated tracking numbers do not become too high. The value at which the signal identifier number is recycled can be any value, but is preferably set at a level which is not too low, resulting in the possibility of confusingly similar tracking numbers if a large number of signals are received in a short period of time, and not so high that the tracking number becomes very large. A range of suitable values is from 1 to between 999 and 9999. After adding the tracking number to the signal data, the signal data can now be stored to a log such as a log file on a data storage device 919, preferably in a text file or database for later analysis, verification, and troubleshooting.

An example of a preferred tracking number generator 915 is a computer program with routines for incrementing numbers and formulating a unique number based upon or including an incrementing number and the time, date, random numbers, or combinations thereof. As an example, if the 200^{th} signal is received at 12:41:50 PM on Jan. 14, 2003 a resulting tracking number could be “2001/14/03_{—}12:41:50” or “200011403124150”.

After the unique tracking number is added, the type of signal sent is determined 920. Signal types include, for example, email messages, alphabetic pages, numeric pages, serial data communications, intra-network communications, inter-network communications, direct file transfer, etc. The signal data contains information about the monitored device and its status and other identification information including, for example, time the signal was sent, date the signal was sent, the identification of the signal source, monitored device identification, monitored device location and current device status information. Other data can be included in the signal data depending upon the monitored device as well as the requirements of the recipient(s). The ANS 900 determines 920 which type of signal has been received, such as by input route or pathway, by the format of the received data, or some other identification information in the signal data. The ANS 900 then processes the signal 930, including extracting data, depending upon stipulated parameters for the particular signal type. These parameters can be permanently or temporarily stored in a data storage device 937, preferably in a text file or database for repeated retrieval and use for multiple received status signals.

The ANS 900 can receive signals from one or more CCPs 600 and other signal sources which can generate and send a properly formatted, text-based signal to the ANS 900.

The ANS 900 then processes 930 the status signal by extracting the data necessary for further signal processing. For an email-type status signal, for example, the time, date, subject line and address information (which includes sender name and domain name) is extracted. A pager-type signal can contain numeric, alphabetic, and symbolic page information as well as any caller identification information.

The resulting signal data is then analyzed to verify 940 one or more parameters to ensure the legitimacy and integrity of the signal; for example, that the data is properly formatted and within acceptable size limits, the authenticity of the source of the signal, any applicable check sum, the presence of any attachment or body in an e-mail signal, the sender name and domain name of any e-mail, the date and time of the signal, the area code, exchange and extension of any page. A method of verification is a computer program which can read the data and evaluate the contents of the data for length and specific content, patterns of characters and numbers, for example. If the data string does not meet one or more of the parameters, for example, the string is too long or too short, the string does not contain the correct formatting or special characters, or the signal source is not identified, the signal data is stored to an error logging means such as a log file on a data storage device 949, preferably in a text file or database, and the processing of that signal is then stopped.

The ANS 900 then parses the signal data and formats 950 the data into a universal data format. This step allows for signal processing to continue in a common method regardless of the original signal source or signal type (e-mail, page, etc.). A signal is formatted by, for example, a computer program which can accept or read data from a file or memory, manipulate the data, and write the manipulated data to a file or location in computer memory. The universal data string includes a plurality of data fields, each separated by a field delimiter. The universal data string can also include a starting identifier, a termination identifier or both, to facilitate subsequent identification and separation of individual signals, and their fields, from a continuous stream of uniform data strings.

Examples of data fields include, but are not limited to: the signal tracking number; signal date; signal time; sender information including, for example, user and domain name for email-type signals, caller ID information for page-type signals; location identification, client identification, device identification, device condition, device status, and signal classification (such as alert, failure, restored, test, enabled, disabled, etc.).

Once the universal data string 955 is generated and formatted it is parsed and validated 960. Validation can be achieved with a computer program which can accept or read data from a file or memory, manipulate the data including comparing two pieces of data, and write the manipulated data to a file or location in computer memory. The validity of the data is checked by comparing values of one or more of the universal data string data fields with acceptable values for the data fields which can be stored on a data storage device 967. Typical data fields include, but are not limited to, time, date, signal source identification, a signal type identifier for identifying the type of signal such as email, alpha page, or numeric page, a signal source identifier for identifying the source of the signal including, monitored device identification, monitored device location, and device status. Device status can be represented by text or numbers, examples of typical status identifiers include, but is not limited to, “alert”, “restore”, “A”, “R”, a two or more digit number corresponding to an “alert”, “restore”, temperature, concentration, contamination level, rpm, PPM, or any other predefined status designation.

The validation process can check for legitimate senders, legitimate devices for a particular sender, legitimate status for a given device, for example. If a data field in the data signal fails validation, the signal is sent to a log, such as a log file on a data storage device 969, preferably in a text file or database, together with additional data which identifies the particular data field which did not validate and the processing of the signal is stopped.

If the signal data is validated as a legitimate signal (e.g., a valid status for an existing device at a valid location) further validation can be used to determine if further action is or is not desired—for example, if no notifications are to be made on weekends, holidays or before 6 AM. The validation process will also eliminate redundant signals from being processed if the two or more redundant signals were received for the same condition for the same device but received from two different signal source paths. A signal is considered validated when all applied validity tests are met.

In one embodiment, a validated signal is processed by one or more filters which reduce or eliminate unwanted, excessive or redundant notifications from being made. A preferred filter is a computer program which can accept or read data from a file or memory, manipulate the data, write the manipulated data to a file or location in computer memory, and generate new data which can be written to a file or stored in memory. Any number of filters can be used alone or in combination depending upon the requirements of the recipient. Filter parameters can be set in each filter for each signal source, monitored device, or any other data field which can identify a signal. Such unwanted, excessive or redundant alerts could, for example, be the result of a rapidly fluctuating monitored condition or a malfunction in a monitored device resulting in multiple alert signals being sent to the ANS 900.

In one embodiment of a filter, a combination of logic, timing and an incremental counter are used to evaluate the current condition of an alerting device and determine if a signal should continue and generate a notification. In an example of a time based filter, if an initial signal indicating an alert status is received, and a resulting initial notification is sent, a second notification will not be sent in response to a subsequent received alert signal if a pre-designated time limit has not passed since sending the initial notification, or receipt of the initial alert signal. Also, a filter can be configured such that if the number and/or timing of successive signals meets or exceeds a predetermined threshold, the device can be effectively disabled.

The filter stores the validated signal, device identification, the last type of notification for that device (e.g., alert, restored, or none) and a notification counter for that device on a data storage device, preferably in a text file or database. The filter will then initiate and start an elapsed-time timer for the device. Each device will have its own independent timer, and each timer will have at least one preset time threshold. Timers are preferably software based, elapsed time counting program components or independent programs. The filter will check the database for a previous entry in the database for the device. If there is a previous entry, and the last notification type for that entry is restore or none, a notification for that device will eventually be generated and sent and the notification counter for that device is set to one. If there is a previous entry, and the last notification type for that entry is an alert the timer means is reset to zero and restarted and the notification counter is incremented by one.

Another example of a filter will check a database which contains a monitored device's identification information and the devices enabled status., i.e., enabled or disabled. If a device has been disabled, no notifications will be generated for that device until the enabled status for that device in the database is reset to an enabled status. A device can be marked as disabled for any number of reasons. In one embodiment the database includes an indicator of the reason for the disabled status. This information could be used, for example, to determine, how, when and by whom the device status can be reset to enabled.

The database is then checked for any entry for the signaling device. If the last signal type for the device is found in the database, and it is a Restore or none, or if no last alert type is found, the signal data is passed along to a call generating means and the alert count field for the device is incremented by one.

If the last signal type was an alert, the timer is reset to its starting state and restarted and the alert count field for the device is incremented by one.

A list generator 970 parses out the location and device fields from the data string and retrieves from a database a list of recipients 977 (for example names and phone numbers), as well as any additional message or information, associated in the database with the specific location and/or device. The list generator then sends the recipient list and associated information to a display 980, such as a printer or CRT, for example.

At this point a live person notifier 990 will make telephone calls to the recipients 1000 on the list. When a valid signal results in a telephone call being made the data string can be stored to a data storage device 997, preferably a text file or database, and can also be printed to a hard copy.

Throughout the above processes data is passed from one means to another, preferably from one computer program or program component to another computer program or program component. The data can be transferred by any known method for transferring such data. The method is not critical as long as the data integrity is maintained. The method selected may depend upon system architecture. For example, if the receiver 910 and the verifier 920 share a common location, the data can be transferred internally via software or hardware connection such as: SCSI, IDE direct connection or by shared, mutual access to a common memory, mutually accessible pointers, variables within a computer program, or mutually accessible data storage device, preferably in a text file or database. If, for example, the formatter 950 and the validator 960 are located at different locations, the signal can be passed via an external hardware connection such as two interconnecting modems, two interconnected serial ports, two interconnected parallel ports, any other kind of port, LAN, WAN, VPN, two interconnected Ethernet ports or other networking ports.

Before the signal is passed along, particularly if the different processes are located in separate locations, the universal data string 955 can be secured by additional formatting using a secure protocol. Passing such a secured data string can be useful to prevent tampering with or spoofing of data strings. An example of a typical secure protocol uses a prefix in each data field of a signal data string with a numeric string of fixed length indicating the length of the data in the following data field. A checksum can also be appended to either a secured or unsecured data string to verify data integrity during subsequent data processing. The resulting secured and/or checksummed universal signal data string can be saved to a data storage device, preferably in a text file or database for archival purposes.

The receiving, verification, validation, list generation, display, and notification processes can each include an ack/nak process for sending and receiving a signal which will verify that the signal was successfully passed between two processes. Such verification typically uses a computer program that will send an acknowledgement signal back to the means which first passed the signal if the signal was successfully passed or a not acknowledged signal if the passed signal was corrupted. If an ack/nak process receives a not acknowledged signal, or if no ack/nak signal is received after a pre-designated time period, the signal will be passed again until an acknowledgement signal is received. An example of a simple ack/nak signal would be the sending of a single character string, such as ASCII (11) for an acknowledgment and an ASCI (22) for a not acknowledgement.

The communication methods, sensors, data storage, controller means, collection means, power supplies, and other elements described herein include any type which performs the designated function in the process and are not intended to be limited to any specific embodiment. For instance, the schematic illustrations exemplifying a selected process as shown herein cannot fully depict event driven models by which the assembly performs any number of given tasks assigned thereto.

While persons skilled in the art will appreciate the numerous and varied potential applications of the present invention, the following examples illustrate advantageous applications of various aspects of the present invention, which are not intended to limit the scope of the invention.

### EXAMPLE #1

A remote Environmental Data-Monitoring-Control unit (EDMC) was assembled by connecting a temperature sensor (ELK-MT100) via a four conductor field wire to an input point on the PLC (ELK-MM443(S), ELK, Hildebran, N.C.). The PLC was connected to an RS-485 (from the PLC) to RS-232e (to the modem) converter (ELKMB485 ). A battery (ELK model 1240) and a power transformer (Amseco-class 2 transformer model XT-2440) were then connected to the power supply/charger (Altronix Power supply/charger model AL624). The power supply/charger provides AC supported power as well as maintaining a back-up battery source of power by switching automatically to the battery upon AC power failure.

The power supply/charger is connected to input points on the PLC such that the PLC senses through one input point the state of the AC supply and through a second input point the current battery level; in this way the power conditions are self supervised and can be sent through the monitoring process. This is common practice for what is known in the art as a “Supervised Power Supply”.

The data is generated by the EDMC is in the form of a cryptic string of information that must be requested, collected, decrypted and displayed.

The PLC was connected through the converter to a wireless modem (Novatel Sage TNC wireless IP modem part number 01016515). The RS-232 port of the Sage modem is connected via standard serial cable to the RS-232 port of the converter.

An address (ID) for the PLC was set via jumper pins located on the PLC board. The wireless modem was assigned a public, static IP address by the wireless service carrier (AT&T). Once the static IP is introduced to the modem all communications with the modem can take place over the Internet. In addition to assigning the static IP to the modem, the CCP has a public, static IP. By using assigned IP addresses the modem's communications are limited to occur between only itself and the static IP of the CCP.

The CCP maintains a database containing relational records of the modem's IP address, the physical location of the modem, all PLC IDs connected to the modem, and all sensors and outputs connected to the PLCs with their respective specifications.

The CCP contains software which will communicate, via the internet and Sage wireless IP modem, with the converter ultimately allowing access to, and communication with, the PLC. Firmware in the Novatel Sage modem upon receiving data from the PLC via the Sage RS-232 port encapsulates the data in a TCP/IP packet and sends the packet to the IP of the CCP over the internet. In the same manner TCP/IP packets sent from the CCP, directed to the IP of the Sage modem are disassembled at the firmware level and the transmitted data only is sent out the Sage's RS-232 port to the PLC.

The CCP is connected to the Internet via a Network Interface Card connected through a router to a permanent Internet connection (Ti). The CCP establishes communication, per TCP/IP protocol standards known to the art, by establishing a socket connection through software. In this example the socket connection was established using an ActiveX™ software running in a Windows™ environment which handles the TCP/IP communication.

Initially, based on what types and style of sensors are used, the CCP is programmed with configuration information for the modem and its associated PLCs, sensors and outputs. This configuration information is sent to the PLC(s) and consists of firmware instruction code that determines set point values for inputs (sensors) and what, if any, action is required upon a given input value exceeding a preset set point. In this Example the temperature probe was given a set point value of 80° F. The CCP sends instructions to the PLC to transmit the value registered by the probe if the 80 ° F. limit is exceeded. The CCP may send instructions to the PLC that an output point (a relay) should also be activated if the limit is exceeded. The relay could then activate an exhaust fan to alleviate the excessive temperature condition, for example. The PLC can be programmed to report to the CCP once the exceeded limit has returned to below its set point value, or its predetermined value less a variable difference. This variable difference is known in the art as a “Deadband”. The purpose of this Deadband is to stop the excessively frequent cycling of a piece of equipment because the state changes on the controlling sensor too rapidly. An example of a common use of such a Deadband is associated with most thermostats' normal operation, typically 5 degrees but in some instances this Deadband is adjustable. With the temperature probe connected, an output point connected to ventilation equipment (exhaust fan), a preset limit of 80° F. and a Deadband of 5° F. the following operations occur in this process.

The temperature sensor was immersed in water until a temperature value of 85.5° was reached causing the PLC to transmit the value immediately to the communications buss of the PLC. Simultaneously the configuration programming caused the state of the output point connected to the ventilation equipment to change to an ON state causing the transmission of a “change of state” communication with the current state of the output point to be placed on the communications buss together with the exceeded set point value of 85.5° F. As all buss communications occur sequentially the first value to depart the buss via the RS-232 interface on the converter is the temperature exceeded. This value is placed in a string of information that includes the encrypted length of the data, the destination of the data, the address (ID) of the PLC board, the address (ID) of the PLC point (sensor), the value at that point (corresponding to 85.5° F. ) and some characters calculated as a checksum to ensure data integrity at the other end of the communication. This data string of information about the temperature value and its origin, here after referred to as the “signal”, is then sent to the Sage wireless IP modem's RS-232 communications port. Once in the modem the signal is encapsulated by the modem's firmware in a TCP/IP packet incorporating all elements necessary to convey that information over the Internet including the point of origin IP (modem) and the point of destination IP (CCP) and port numbers for transmission purposes. When the packet arrives at the CCP the signal is removed from the packet and the additional information of origin IP, destination IP and ports etc. is parsed and stored to memory. The signal is checked for its integrity against its own checksum then if the signal integrity is verified, the signal is parsed into its basic elements of length, PLC address (ID) point sending (sensor or output ID), and value sent. As each modem's IP address is unique in the world it is used to identify the site where the packet and signal originated thereby is used to locate database records which include the number and types of PLCs, sensors and outputs connected to, and associated with, the source IP (i.e., modem) The parsed signal information is then compared to values for PLCs, sensors and outputs in the database records specifically for the originating IP address of the packet. Once the specific point (sensor) has been determined from the information the value is compared to a table to determine its meaning, i.e., whether it is a temperature in degrees or whether it is Parts Per Million (PPM) and whether any appropriate conversion to express that meaning is made. The signal and all its parsed data is logged to a file on the CCP and stored.

In this Example it is “facility Temperature”. Now that the specific nature and origin of this signal have been determined the condition is reported to an end user in two ways.

The CCP sends an alert email to the ANS. The signal information is placed in subject line of the email, formatted for proper interpretation by the ANS. The ANS generates a call from a live person informing the recipient of the phone call of the identity and location of the sensor and that the temperature for the sensor has exceeded its limit and is currently at 85.5° F.

In addition, the source information and signal information are formatted, using hypertext markup language (HTML) to be viewable by the end user on a web page on the CCP. Additional content, such as identifying labels, instructions, graphics, and hypertext links, are combined with the information. The resulting code (HTML) is sent to the end user in an active web-browsing session, if any, and can be stored for later viewing. The stored signal and all its parsed data can be accessed later by a web-enabled program or script, Perl, CGI, JAVA, ASP, Cold Fusion, PHP, for example, to generate a web page.

### EXAMPLE #2

The system and process of Example 1 are repeated except that the set point for the temperature sensor is not exceeded. Instead, a software based timer initiates a signal with the sensor value to be sent every hour. Each requested signal is parsed and saved in a database on the CCP. Hypertext link buttons or data in a form are submitted by the end user through a web page. This invokes a web-enabled script which queries the database, using structured query language (SQL), for example, and generates a web page with the requested data and sends it to the end user in the current, open, web browsing session. The data can be textual or converted to be shown in a graphical manner. This is used for example, to show trending data, i.e., values over an extended period of time.

The web page uses methods, well known in the art, to submit data and requests to a program over the internet including hyperlinks and forms.

The actual contents and choices of actions of a web page can be altered dependent upon the end user who is required to log on to the web page using common security checks. The user's viewable web page can be static, hard-coded or previously generated, or can be dynamically generated on-the-fly. Examples of possible actions include:

A form, which has fields identifying a list of sensors and a range of dates, initiates a script or program which accesses and queries the database on the CCP 600 and displays the records for that sensor for the requested dates in textual form or with further processing converts the data to a graphical representation which is then displayed on the web page.

### EXAMPLE #3

The system and process of Example 2 are repeated except that a hyperlink, when selected, sends instructions to the CCP 600 to initiate a script or program which sends a command to the EDMC 150 to activate an output, resulting in a ventilation fan being turned on at the location of the EDMC 150. The CCP 600 will process any feedback signal from the EDMC 150 and redraw or update the web page to signify that the requested action was successful, changing the color of the hyperlink, for example.

### EXAMPLE #4

The system and process of Example 2 are repeated except that a hyperlink, when selected, can send instructions to the CCP 600 to initiate a script or program which sends a request to the EDMC 150 to request and send the value of a specified input (e.g., sensor). The CCP 600 will process the requested signal from the EDMC 150 and redraw or update the web page to signify the current value of the input, in readable format, temperature in Degrees Fahrenheit, for example.

### EXAMPLE #5

The system and process of Example 2 are repeated except that a form, which has fields to identify a targeted sensor and the available set points with allowable limits for that sensor, is submitted from the web page and a script or program sends the data to the EDMC and PLC which contain the targeted sensor with instructions for the PLC to update the logic 220 on the PLC used for evaluating values from the targeted sensor.

### EXAMPLE #6

In this example, a controlling signal is sent from the web page to the PLC of Example 1. In this circumstance a button placed on the web page in a graphical representation of the connected field devices would be selected and clicked sending information that would include the origin device, destination site, destination PLC, destination output point, destination output point value. This information is derived from the pre-knowledge of end user devices located at the site as described in the initial installation. Once pressed the Server collects the required information from a text file, compares the information to the information contained in tables in the Server, converts the information to values allowable by the PLC, concatenates this information to form the base signal string then calculates a valid checksum adding that to the base string. The Server verifies the integrity and accuracy of the collected information at time of signal string assembly to ensure that a requested action is possible and if not the Server returns an error message to the Web page. If the signal is in fact valid the new signal is packaged by the ActiveX component in TCP/IP compliance and sent to the Client where the firmware disassembles the signal from the TCP/IP packet and sends the signal to the RS-232 port of the Sage wireless modem. This signal leaves the Sage RS-232 port and enters the RS-232 port of the ELK-MB485 converter that transfers the information to the data buss of the PLC(s) on site. The PLC targeted for delivery sees the segment of the string identifying it as the target PLC and absorbs the information evaluating the checksum and acting upon the signal if the checksum validates. As a result of this action a return signal or “status” signal is generated and sent back through the process in the same manner and direction as the original unsolicited signal resulting in a second signal to be sent to the web page.

The arrival of the signal at the web page will most likely trigger a reaction to indicate the status of the output such as a graphical representation of a green and red light going on and off to indicate status. In the previous example onboard configuration code caused the ventilation equipment to come on. In this example we can suppose that no such automated action is desired by the end user of the equipment. The end user instead uses the live notification option whereby the CCP sends a signal via the Alert Notification System causing the end user to receive a phone call alerting him to the potential hazard at his site. The end user then logs on to his secure web page and determines if conditions are such as to warrant the intervention of the ventilation equipment. If the end user decides such intervention is required the user can select and click the button on screen which begins the aforementioned process to engage and verify the activation of the ventilation equipment.

### EXAMPLE #7

The system and process of Example 1 are repeated except that the temperature sensor is a Siebe (a.k.a., Invensys Building Systems, Loves Park, Ill.) model TS-5821-101 electronic immersion sensor, Platinum Element; the PLC is a Siebe model MSC-MPC Multi Purpose Controller; the converter is a Siebe model MSC-LIM Laptop Interface Module.

### EXAMPLE #8

The system and process of Example 1 are repeated except that the PLC is a “Basic Stamp 2” (Parallax, Inc., Rocklin, Calif.).

### EXAMPLE #9

The system and process of Example 1 are repeated except that the power supply/charger and transformer are removed. The EDMC runs off of battery power only. Such an EDMC is useful for temporary installations and can be remotely deployed, for example by aerial deployment via parachute or by remotely controlled robot.

### EXAMPLE #10

The system and process of Example 1 are repeated except that the power supply/charger is replaced with Solar panels and a Solar Cell replaces the ELK 1240 battery.

### EXAMPLE #11

The system and process of Example 1 are repeated except that the modem is replaced with a Ethernet network interface card (SMC) and the NIC is connected to the Internet via a router with an Internet connection.

### EXAMPLE #12

The system and process of Example 1 are repeated except that the modem is replaced with a wired, external modem (Zoom Technologies External Modem Model 2855-PC) and the modem is connected to the Internet via a POTS telephone line. Since the modem does not have an IP address, the address (an alphanumeric string ID) for the PLC was set by programming the PLC board.

### EXAMPLE #13

The system and process of Example 12 are repeated except that the modem is connected to the Internet via an ISDN line.

### EXAMPLE #14

The system and process of Example 12 are repeated except that the modem is connected to the Internet via a DSL line.

### EXAMPLE #15

The system and process of Example 12 are repeated except that the modem is connected to the Internet via a cellular wireless service.

### EXAMPLE #16

The system and process of Example 1 are repeated except that the EDMC is replaced with a user's proprietary control system which is capable of creating compatible signals, pages, or e-mails, for example, that can be sent through the communications device for alerts, trending and real time notification.

### EXAMPLE #17

The system and process of Example 1 are repeated except that an EMDC is not employed by the user. The user can establish direct communication with the ANS using pre-existing PLC equipment which can send either an email or alphanumeric/digital page configured such that the specific point and it's related value are transmitted in a compliant format to the notification process.

### EXAMPLE #18

The system and process of Example 1 are repeated and the ANS processes the alert signal sent from the CCP utilizing the following process:

The signal data source is first verified. If the signal source was an e-mail, the domain from which the e-mail was sent is cross-checked against a list of valid domains associated with the valid IP/device/status of the signal, said list of associated domain names being stored on a data storage device, preferably in a text file or database. If a match is not found, the signal data is stored in a data storage device, preferably in a text file or database designated for such errors for any of the data storage device, preferably in a text file or database for storing invalid signals. An identifier may be added to the signal data for further evaluation of where the process was stopped or any alternative separate data storage device, preferably in a text file or database may be used for each data verification step,

If a match for the domain is found, the user information in the data signal is cross-checked against a list of valid users for the IP/device/status/domain. If no user is matched, the signal data is stored to a data storage device, preferably in a text file or database designated for such errors and no further action is taken on this signal.

If the signal was received as a page, the area code and the sending telephone number is cross checked against a list of valid area codes designated for the device indicated in the data string which is stored on a data storage device, preferably in a text file or database. If no such match is made, the signal data is stored in a data storage device, preferably in a text file or database designated for such signal. If a valid area code match is made, the sending telephone number exchange is cross matched for a valid sender telephone number exchange list associated with said IP/device/status/area code signal, said list being located on a data storage device, preferably in a text file or database. If there is no match, the signal data is sent to a data storage device, preferably in a text file or database designated for such errors and no further action is taken on the signal. If an exchange match is found, the extension of said sender telephone number is cross-checked against valid extensions for said IP/device/status/area code/exchange stored on a data storage device, preferably in a text file or database. If no valid extension is found, the data signal is stored to a data storage device, preferably in a text file or database designated for such errors. If an exchange is found, the signal is checked for valid transport. The mode of transport of the data signal (i.e., e-mail, alpha page, numeric page, RS232 connection, etc.) is cross-checked against a list of valid transport modes associated with said combination of IP/device/status/email/page. If no valid mode of transport match is made, the data signal is stored to data storage device, preferably in a text file or database designated for such errors and no further action is taken on the signal. If it is verified that the signal was sent with a valid mode of transport, the evaluation means cross checks the IP address from the signal data with the existing, valid IP addresses in one of said data storage device, preferably in a text file or database. If no matching IP address is found, the signal data is stored in a data storage device, preferably in a text file or database reserved for such invalid signals and the process is stopped with no further action being taken on the signal data. If the IP address is valid, the evaluation means cross checks the device ID from the signal data from a list of possible valid device ID's which have been designated as associated with the valid IP address, said information being stored in a data storage device, preferably in a text file or database. If the device ID does not match any valid device ID, the signal data is stored to a data storage device, preferably in a text file or database designated for such errors and the process is stopped with no further action being taken on the signal

The signal data status is then cross-checked against valid status for the already verified valid IP address and IP device. If no such valid condition is found, the signal data is stored to a data storage device, preferably in a text file or database designated for such errors and the process is stopped with no further action being taken on this signal. If the condition is valid the signal is checked for a valid schedule.

If the schedule allows for notification, a list of recipients to contact is generated based upon the subject device or sensor. A live operator then calls one or more recipients on the list describing the type of alert, the device and status of the device.

While the foregoing invention has been described with reference to the above embodiments, various modifications and changes can be made without departing from the spirit of the invention. For example, while the Examples use a temperature sensor, many other possible sensors can be used. Other proprietary and commercial PLCs can be used as well as other methods and equipment for communication between the EDMCs and CCP are also contemplated and are intended to be within the scope of this invention. Accordingly, all such modifications and changes are considered to be within the scope of the appended claims.

What is claimed is:

1. A method for remotely monitoring at least one condition at a given location comprising:
providing at least one monitoring device at said given location; said monitoring device generating data indicative of said monitored condition and transmitting said data in a given protocol dependent upon at least one characteristic of said device;
wrapping said transmitted data into said protocol;
transmitting said protocol wrapped data to a remote, centralized, data collection device;
receiving said transmitted wrapped data using said centralized, data collection device;
parsing said received protocol wrapped data to identify said data indicative of said monitored condition from said protocol wrapped data; and,
generating at least one data string using said data indicative of said monitored condition.

2. The method of claim 1 wherein said protocol is Transmission Control Protocol/Internet Protocol (TCP/IP) which uses a TCP/IP header.

3. The method of claim 1 wherein said protocol wrapped data is transmitted over a computer network.

4. The method of claim 1 wherein said centralized data collection device has a static IP address associated therewith, and said protocol wrapped data is transmitted to said static IP address.

5. The method of claim 1 providing two or more monitoring devices.

6. The method of claim 1 providing at least one monitoring device at each of two or more given locations.

7. The method of claim 1 wherein said at least one condition comprises a plurality of conditions.

8. A method for remotely monitoring at least one condition at a given location comprising:
providing at least one monitoring device at said given location; said monitoring device generating data indicative of said monitored condition and transmitting said data in a given protocol dependent upon at least one characteristic of said device;
wrapping said transmitted data into Transmission Control Protocol/Internet Protocol (TCP/IP) including a TCP/IP header;
transmitting said TCP/IP protocol wrapped data to a static IP address;
receiving said transmitted TCP/IP wrapped data using said static IP address;
parsing said received TCP/IP wrapped data to separate said data indicative of said monitored condition from said TCP/IP header;
determining said given protocol using said parsed TCP/IP header; and,
generating at least one data string indicative of said monitored condition using said data indicative of said monitored condition and said determined given protocol.

9. The method of claim 8, wherein said monitoring device comprises a programmable logic controller.

10. The method of claim 8, wherein said generated data includes data indicative of said monitoring device.

11. The method of claim 10, wherein said data indicative of said monitoring device includes an address.

12. The method of claim 11, wherein address is programmed in said monitoring device.

13. The method of claim 8, further comprising generating at least one electronic document using said data string.

14. The method of claim 13, wherein said electronic document is available via a computer network via a web browser.

15. The method of claim 14, wherein said electronic document is in HTML.

16. The method of claim 8, further comprising cumulatively storing said generated data string.

17. The method of claim 16, further comprising generating an electronic document indicative of one or more of said stored data strings.

18. A method for remotely and at least partially reprogramming at least one monitoring device present at a given location; said monitoring device generating data indicative of said monitored condition and transmitting said data in a given protocol dependent upon at least one characteristic of said device;
generating at least one data string indicative of a change in programming for said monitoring device at a remote location distinct from said given location in a given protocol associated with said at least one device;
wrapping said at least one data string in Transmission Control Protocol/Internet Protocol (TCP/IP) including a TCP/IP header;
transmitting said TCP/IP protocol wrapped data to an IP address associated with said at least one device;
unwrapping said TCP/IP protocol wrapped data; and,
retransmitting said unwrapped data in said given protocol.

19. A method for sending live, telephonic notification to a list of one or more designated recipients of a condition of an apparatus comprising:
receiving at least one notification data string indicative of the condition of the apparatus, said notification data string having data indicative of the apparatus and the condition,
verifying the format and source of said at least one notification data string;
validating the data in said at least one notification data string;
generating a list of contact information for said one or more designated recipients; and,
initiating a telephone call to said one or more designated recipients.

20. The method of claim 19, wherein said at least one notification data string was received by email or page.

21. The method of claim 19, further comprising
generating said at least one notification data string, said notification data string being capable of being transmitted remotely via a protocol; and
transmitting said at least one notification data string to a receiving means.

22. The method of claim 21, wherein said protocol is selected from the group consisting of an email protocol, a numeric page protocol and an alpha-numeric page protocol.

23. A system for the telephonic notification of one or more recipients of a condition of an apparatus comprising:
a signal receiving means for receiving a signal, said signal containing data indicative of the apparatus and the condition of the apparatus;
a signal processing means for verifying, extracting, and validating the data in said received signal;
a contact generation means for generating contact information for one or more recipients, said contact information being at least partially based upon the apparatus and the condition of the apparatus;
a notification means for telephoning said one or more recipients and notifying said one or more recipients of the condition of the apparatus.

24. The system of claim 23, further comprising:
a signal generating means for generating a signal, said signal comprising at least one data string indicative of the identity and condition of the apparatus; and,
a signal sending means for remotely transmitting said signal;

25. The system of claim 23 wherein the signal is an email or page.

26. A system for the telephonic notification of one or more recipients of a condition of an apparatus comprising:
a signal receiver for receiving a signal, said signal containing data indicative of the apparatus and the condition of the apparatus;
a signal processor for verifying, extracting, and validating the data in said received signal;
a contact generator for automatically generating contact information for one or more recipients, said contact information being at least partially based upon the apparatus and the condition of the apparatus;
a calling station for use by an operator for telephoning said one or more recipients and notifying said one or more recipients of the condition of the apparatus.

27. The system of claim 26, further comprising:
a signal generator for generating a signal, said signal comprising at least one data string indicative of the identity and condition of the apparatus; and,
a signal sender means for remotely transmitting said signal.

28. The system of claim 26 wherein the signal is an email or page.
